(19) United States
(12) Patent Application Publication
(10) Pub. No.: US 2007/0267838 A1
(43) Pub. Date: Nov. 22, 2007

(54) SYMMETRICAL A-ARM FOR GOLF CAR AND OFF-ROAD UTILITY VEHICLES

(75) Inventors: Anthony J. Sanville, Evans, GA (US); William Mosuch, Augusta, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/419,409

(22) Filed: May 19, 2006

(51) Int. Cl. B60G 7/00

(52) U.S. Cl. 280/124.134

(57) ABSTRACT

A golf car includes an independent front suspension system having an identical pair of A-arms reversibly arranged with respect to each other. Each A-arm includes a Y-shaped, flat plate body having a first end and a second end. A first tube member is welded to the first end. A second tube member is also welded to the first end and is spatially separated from the first tube member. The second tube member is co-axially oriented with the first tube member. A third tube member is welded to the second end of the body. A longitudinal axis extending through the first and second tube members is parallel to a third tube member longitudinal axis. Each of the first and second tube members are connected for co-rotation about the longitudinal axis to a frame structure of the golf car. The third tube member is connected to a wheel structure.

### FIELD

The present disclosure relates to devices and methods for manufacturing suspension system components used, for example, in golf car and off-road utility vehicles.

### BACKGROUND

Many golf car designs commonly have single axle suspension systems for both the front steerable wheels and the rear driving wheels. A solid axle provides a stiffer ride feel for the occupants and can also result in reduced control of the golf car over rough terrain and when turning at higher speeds. Some golf car designs have therefore used an independent suspension system supported by A-arms for at least for the front steerable wheels which eliminates the solid axle and separately suspends each front steerable wheel from the frame or structure of the golf car.

Drawbacks of existing independent suspension designs for golf cars include the structure of the A-arm assemblies used to independently mount the steerable wheels. Castings have been used in these applications which are expensive to manufacture and are susceptible to cracking or breakage upon receipt of high impact loads which can occur if one of the steerable wheels strikes a stationary object. An improved A-arm design is therefore desirable for independent suspensions for golf cars as well as other similar utility vehicles.

### SUMMARY

According to various embodiments, a suspension system A-arm for a utility vehicle can have a generally Y-shaped, flat plate body having a first end and a second end. A first and a second extension portion define the first end. A first tube member can be connected to the first extension portion. A second tube member can be connected to the second extension portion, the second tube member being positioned in co-axial alignment with the first tube member. A third tube member can be connected to the second end of the body. A longitudinal axis extending through the first and second tube members is substantially parallel to a third tube member longitudinal axis.

According to other various embodiments, a suspension system A-arm for a golf car can include a generally Y-shaped, flat plate body having a first end and a second end. A first tube member can be connected to the first end. A second tube member can also be connected to the first end and spatially separated from the first tube member. The second tube member can be positioned in co-axial alignment with the first tube member. A third tube member can be connected to the second end of the body. A plurality of body edges includes a first edge extending between the first tube member and the second tube member. A second edge extends between the first tube member and the third tube member. A third edge extends between the second tube member and the third tube member.

In still other various embodiments, a golf car includes an independent front suspension system having an identical pair of A-arms reversibly arranged with respect to each other. Each A-arm includes a Y-shaped, flat plate body having a first end and a second end. A first tube member is connected to the first end. A second tube member is also connected to the first end and is spatially separated from the first tube member. The second tube member is co-axial with the first tube member. A third tube member is connected to the second end of the body. A longitudinal axis extending through the first and second tube members is parallel to a third tube member longitudinal axis. Each of the first and second tube members are connected for co-rotation about the longitudinal axis to a frame structure of the golf car. The third tube member is connected to a wheel structure.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car having a reversible A-arm suspension system member according to various embodiments;

FIG. 2 is a perspective view of an independent suspension system for the golf car of FIG. 1;

FIG. 3 is a perspective view of an A-arm of the present invention;

FIG. 4 is a top plan view of the A-arm of FIG. 3;

FIG. 5 is a first side elevational view of the A-arm of FIG. 4;

FIG. 6 is a second side elevational view of the A-arm of FIG. 4;

FIG. 7 is a front elevational view of the left handed wheel assembly of FIG. 2 showing the A-arm connected to exemplary suspension members of the suspension system of FIG. 2 according to various embodiments;

FIG. 8 is a side elevational view taken at view 8-8 of FIG. 7; and

FIG. 9 is plan view taken at view 9-9 of FIG. 7.

### DESCRIPTION OF VARIOUS EMBODIMENTS

The following description of various embodiments is merely exemplary in nature and is in no way intended to limit the present disclosure, its application, or uses. Throughout this specification, like reference numerals will be used to refer to like elements.

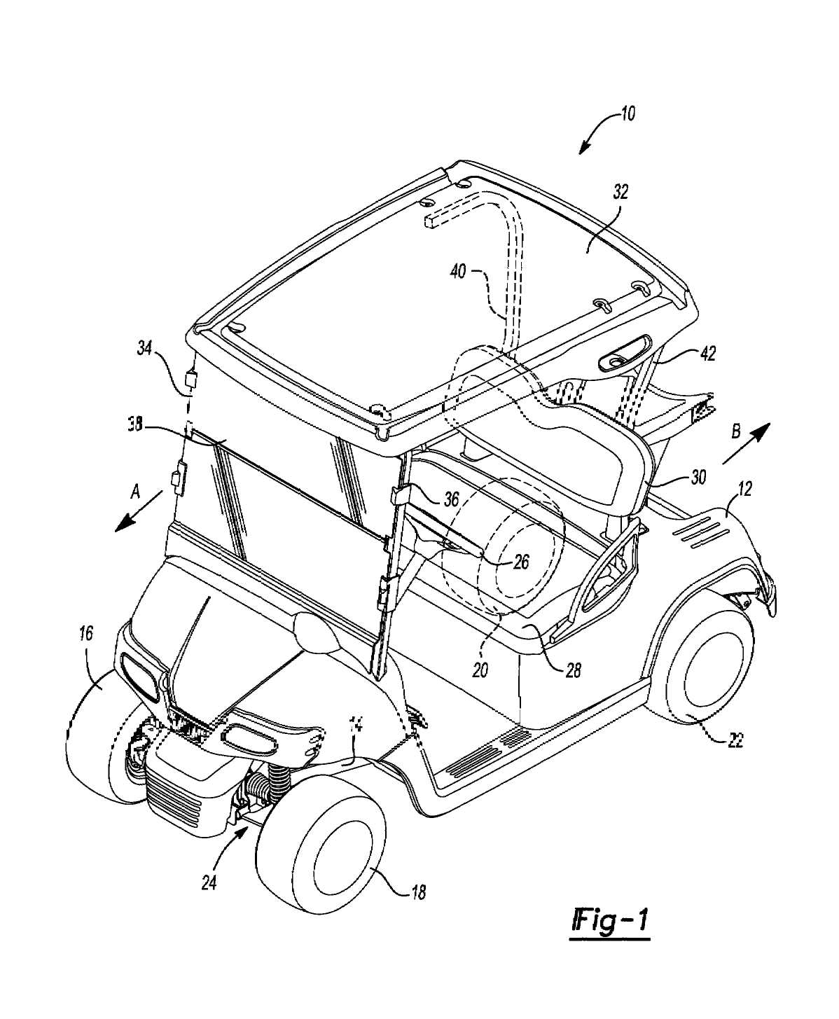

Referring generally to FIG. 1, a golf car 10 includes a body 12 supported from a structural frame 14. Frame 14 can also support a plurality of wheels including a first steerable wheel 16 and a second steerable wheel 18. In addition, powered or driven wheels including a first driven wheel 20 and a second driven wheel 22 are commonly connected to a rear structural portion of frame 14. A suspension system 24 can also be provided which is adapted for steering each of the first and second steerable wheels 16, 18. A steering mechanism 26 which commonly includes a steering wheel and a support post assembly can also be connected to suspension system 24 to provide the necessary steering input to first and second steerable wheels 16, 18.

Golf car 10 can also include a passenger bench seat 28 and a passenger back support cushion 30. A cover or roof 32 can also be provided which is supported from either body 12 or frame 14 by first and second support members 34, 36. A windshield or windscreen 38 is also commonly provided which is also supported by each of first and second support members 34, 36. A rear section of roof 32 can be supported by each of a first and a second rear support frame element 40, 42. Other elements which are commonly provided with golf car 10 include golf bag support equipment, accessory racks or bins, and other optional equipment such as environmental covers which are not shown in FIG. 1 for clarity.

Golf car 10 is commonly propelled using an engine or battery/motor system which is commonly provided below bench seat 28. Golf car 10 is capable of motion in either of a forward direction “A” or a rearward direction “B”. Each of first and second steerable wheels 16, 18 can be simultaneously rotated or turned using steering mechanism 26. Each of first and second steerable wheels 16, 18 are also independently supported to frame 14 using suspension system 24. This permits each of first and second steerable wheels 16, 18 to deflect upwardly or downwardly as viewed in FIG. 1 independent of each other.

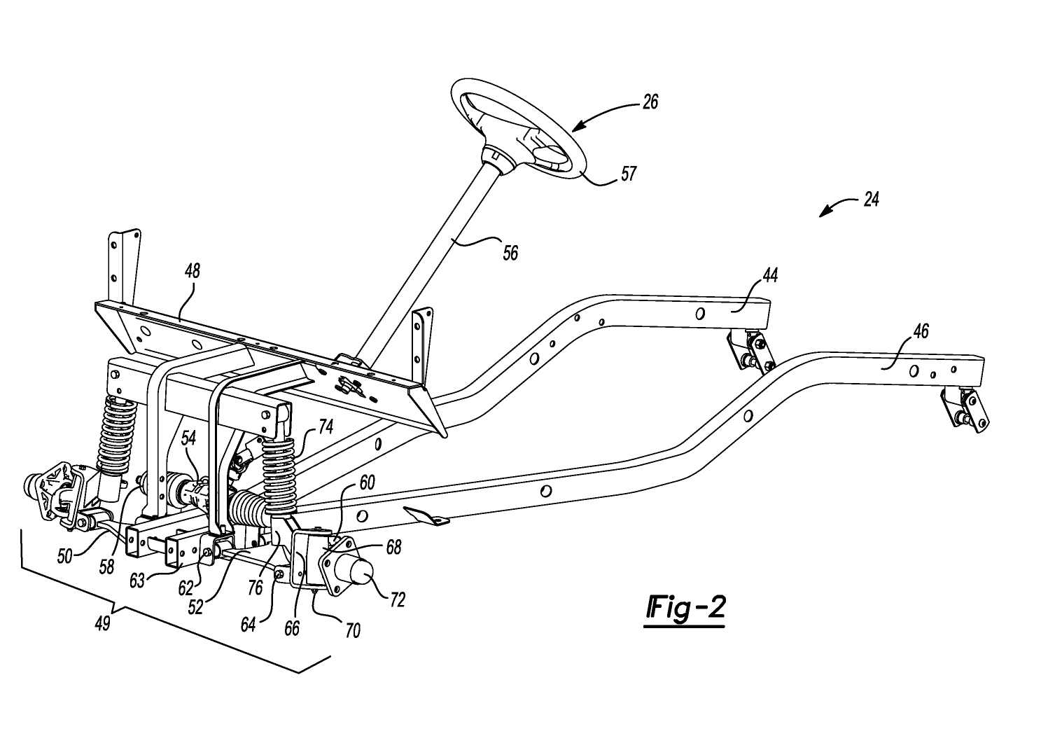

As best seen in reference to FIG. 2, frame 14 can further include a first frame member 44 and a second frame member 46. First and second frame members 44, 46 can be hollow, rectangularly shaped members which are created of a steel material or similar structural material and formed by welding, extruding, hydroforming, or similar process(es). A support structure 48 can be connected to and supported by each of first and second frame members 44, 46. Support structure 48, together with first and second frame members 44, 46, support an independent suspension system 49. Independent suspension system 49 supports each of the first and second steerable wheels 16, 18 shown in FIG. 1.

Independent suspension system 49 can include a first A-arm 50 and a second A-arm 52 of the present disclosure. Each of first and second A-arms 50, 52 are a pair of identical A-arms which are reversibly disposed to create a right hand and a left hand wheel support assembly. Because each of the right hand and left hand wheel support assemblies are substantially identical, only the left hand wheel assembly having second A-arm 52 will be further discussed herein.

A steering gear 54 coupled to a steering column 56 receives a manual turning force from a steering wheel 57. A bellows 58 protects a further portion of steering mechanism 26 associated with steering gear 54. A steering arm 60 can extend from bellows 58 and connect to a spindle 68. Spindle 68 can be rotatably joined to a wheel support structure or steering knuckle 66 using a knuckle pin 70. Spindle 68 can be rotatably coupled to a wheel hub 72 which allows rotation of second steerable wheel 18. When directed by steering gear 54, steering arm 60 can direct rotation of spindle 68 and thereby turn second steerable wheel 18. In addition to the connection provided to second frame member 46 by second A-arm 52, steering knuckle 66 can be also connected to support structure 48 using a spring/shock absorber assembly 74 which is connected to steering knuckle 66 using a mount arm 76.

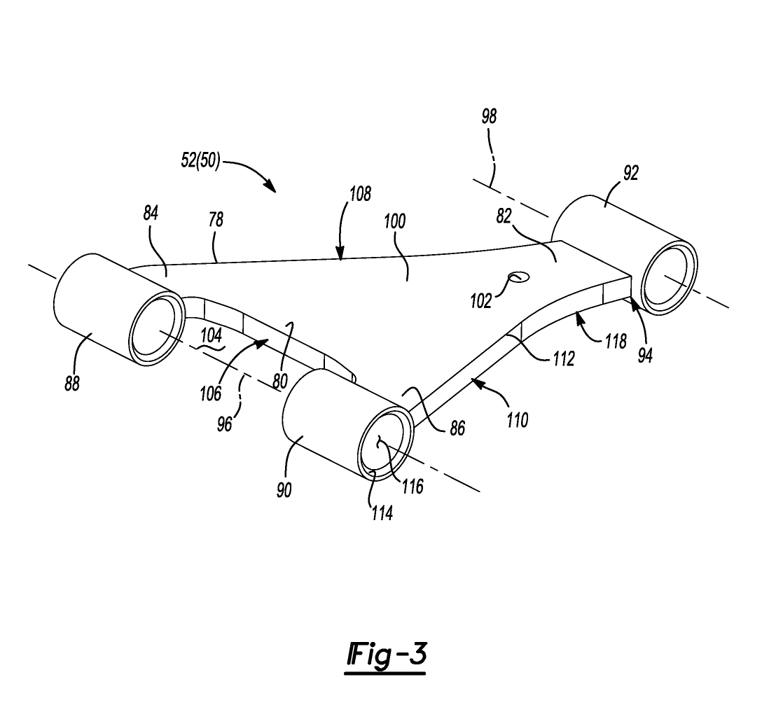

Referring generally now to FIG. 3, a single A-arm assembly is reversible to provide both a first and a second A-arm 50 and 52. Each A-arm 50, 52 can include a flat plate body 78 having a first end 80 and a second end 82. First end 80 can further include a first extension portion 84 and a second extension portion 86. A plurality of tube members are fixedly connected to flat plate body 78 including a first tube 88 connected to first extension portion 84 and a second tube 90 connected to second extension portion 86. A third tube 92 can be connected to second end 82. Each of the first, second, and third tubes 88, 90, 92 can be connected to flat plate body 78 for example using a welded joint such as a fillet weld. A first longitudinal axis 96 is defined through each of first and second tubes 88, 90 such that first and second tubes 88, 90 are co-axially aligned on first longitudinal axis 96. First, second, and third tubes 88, 90 and 92 can be cut from tubing or piping and can be formed from a metal, such as but not limited to steel, aluminum, titanium, or magnesium, and in several embodiments are created from tubing made of 1018 or 1020 cold rolled steel. The tubing or piping material can also be used for body 78.

A second longitudinal axis 98 defined through third tube 92, is oriented substantially parallel to first longitudinal axis 96. Flat plate body 78 can further include a first plate surface 100 which can include a fixture pin aperture 102. Fixture pin aperture 102 can function as a centering aperture when used in conjunction with a fixture to hold body 78 during welding of tube members 88, 90, 92. A clearance cavity 104 is also provided between first and second tubes 88, 90. Clearance cavity 104 allows unimpeded rotation of the A-arm about first longitudinal axis 96. Each of a plurality of side walls extends substantially perpendicular to first plate surface 100. The side walls can include a first side wall 106 extending between first and second tubes 88, 90, a second side wall 108 extending between first tube 88 and third tube 92, and a third side wall 110 extending between second tube 90 and third tube 92. Additional or fewer side walls can also be used in other embodiments of the present disclosure. Each of the first, second, and third side walls 106, 108, 110 can further include a square-edged or beveled corner 112 at the junction between the side wall and the first plate surface 100.

Each of the tubes 88, 90, 92 can further include a chamfer at both ends of the tube to support insertion of a bearing or resilient bushing (not shown), into a central bore 116. The body 78 can further include a second plate surface 118 facing opposite to first plate surface 100 and substantially parallel to first plate surface 100. Individual ones of first and second A-arms 50, 52 are therefore substantially indistinguishable from each other, and can be used as mirror image installations of each other, defining one or more pairs of A-arms.

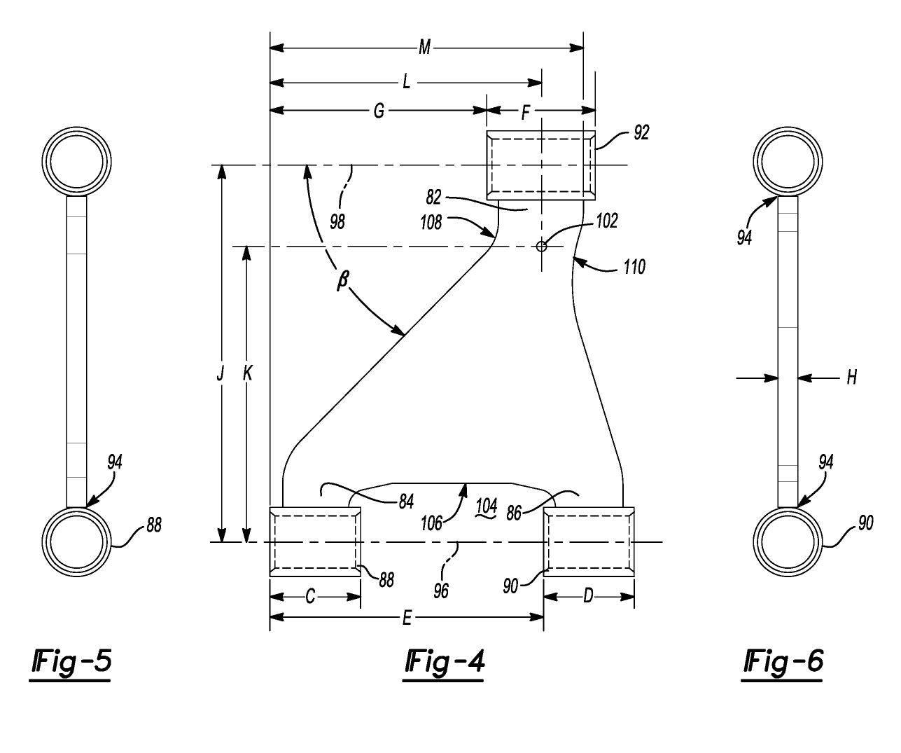

As best seen in reference to FIGS. 4 through 6, first tube 88 has a length “C” and second tube 90 has a length “D”. In some embodiments, length “C” and length “D” are substantially equal. Second tube 90 is positioned with respect to first tube 88 by a tube spacing dimension “E”. In some embodiments, tube spacing dimension “E” is approximately 138.2 mm. Third tube 92 has a third tube length “F” which in various embodiments is greater than either of first and second tube lengths “C” and “D”. Third tube 92 is spatially separated from first tube 88 by a third tube positioning dimension “G”. In various embodiments, third tube positioning dimension “G” is approximately 109 mm. Body 78 has a plate thickness “H”, which in some embodiments is approximately 10 mm.

First longitudinal axis 96 is spaced from second longitudinal axis 98 by an axis spacing dimension “J”, which in some embodiments of the present disclosure is approximately 190.8 mm. Fixture pin aperture 102 is located from first longitudinal axis 96 by an aperture locating dimension “K” which in some embodiments is approximately 150 mm. Fixture pin aperture 102 is further located with respect to first tube 88 by a second aperture locating dimension “L”, which in some embodiments is approximately 136.2 mm. An outside facing end of first tube 88 is positioned with respect to third side wall 110 proximate second end 82 by a locating dimension “M” which in some embodiments is approximately 157.5 mm.

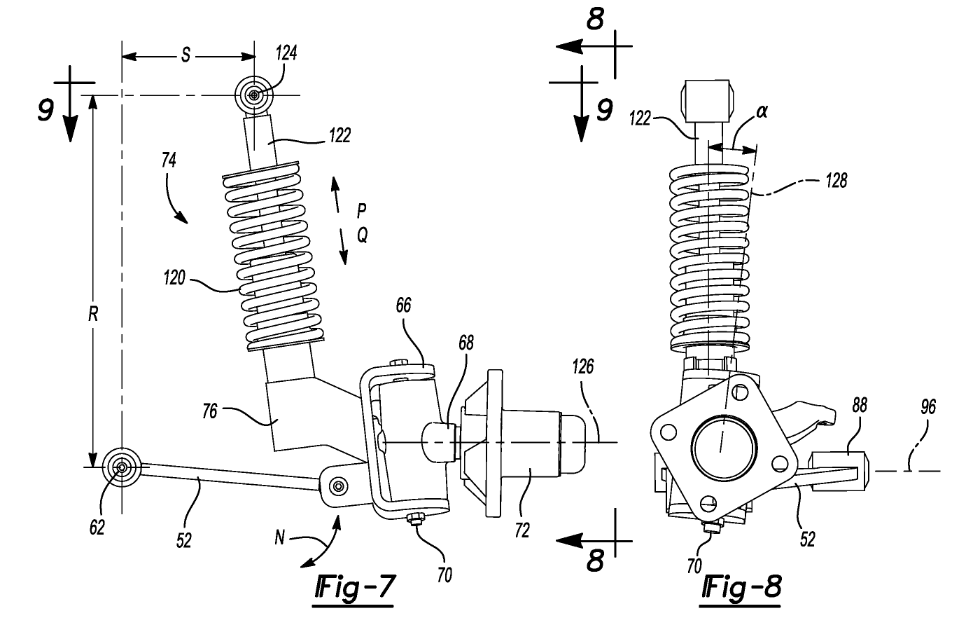

Referring generally now to FIG. 7, details of the left handed wheel support assembly are shown. The right hand wheel support assembly having first A-arm 50 are a mirror image of the left handed wheel support assembly. Second A-arm 52 is rotatably supported by pins 62 inserted through first and second tubes 88, 90 to permit steering knuckle 66 and wheel hub 72 to rotate about a wheel deflection arc “N”. A coil spring 120 and a shock absorber 122 of spring/shock absorber assembly 74 can deflect to allow motion of spring/shock absorber assembly 74 in each of a compression direction “P” and an expansion direction “Q”. Shock absorber 122 can be fixedly connected with a mounting pin 124 to support structure 48. A predetermined vertical distance “R” which in some embodiments is substantially equal to 332.7 mm, and a predetermined horizontal distance “S” which in some embodiments is substantially equal to 114.5 mm provide the fixed points of reference for rotation of second A-arm 52 with respect to pin(s) 62 and mounting pin 124. Second steerable wheel 18 can be rotatably mounted on wheel hub 72 along a hub rotation axis 126.

As best seen in reference to FIG. 8, a nominal angle α is defined between a longitudinal axis of shock absorber 122 and a knuckle pin axis 128. In some embodiments, angle α is approximately 38°.

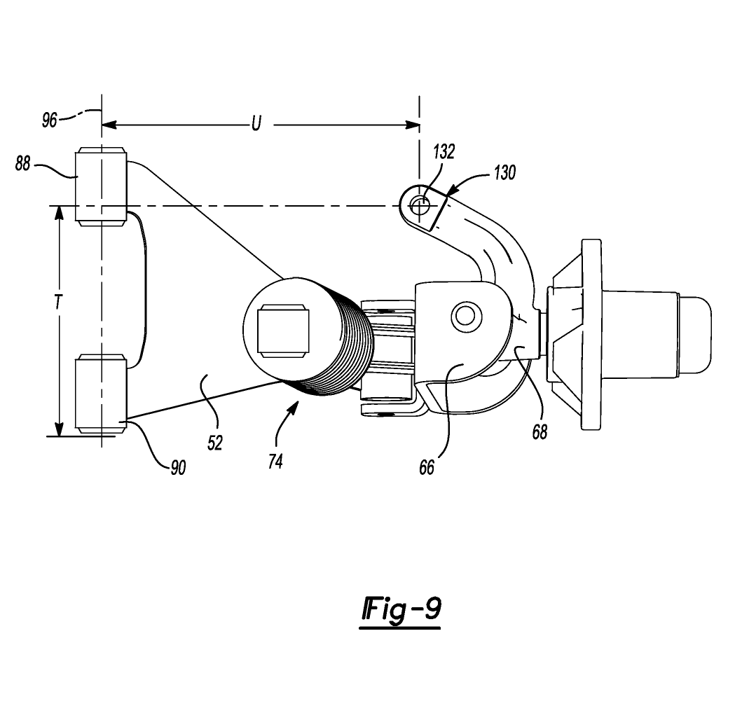

Referring now to FIG. 9, a steering arm 130 can be fixedly coupled to spindle 68 for rotation of spindle 68 in response to the force imparted from steering arm 60 when steering wheel 57 is rotated. Steering arm 60 can be rotatably connected to steering arm 130 using a pin (not shown) centrally positioned within a pin aperture 132 of steering arm 130. A separation distance “T” is provided from an exterior or outward facing end of second tube 90 and the rotational centerline of pin aperture 132. The centerline of pin aperture 132 is also spaced from first longitudinal axis 96 by a spacing dimension “U”. In some embodiments of the present disclosure separation distance “T” is approximately 148.7 mm and separation distance “U” is approximately 211 mm.

First and second A-arms 50, 52 of the present disclosure can be formed by a machining, cutting, or water lancing process which also creates the first, second and third side walls 106, 108, 110. This construction forms A-arms 50, 52 as flat plate configurations which are generally at least as strong as cast A-arm assemblies, however, A-arms of the present disclosure are lighter and less expensive than their cast counter-parts and are less susceptible to damage from twisting loads due to impact of a wheel to an object. Also, by using tubing for the bearing sleeves or tubes of first, second and third tubes 88, 90, 92, no further machining of the bores of these tubes is required, which is commonly required for the integrally cast bores when cast parts are used in these applications. Co-axial alignment of first and second tubes 88, 90 as well as alignment of first and second tubes 88, 90 to third tube 92 can be maintained by welding these tubes in a fixture. This simplifies construction of the A-arms of the present disclosure. The use of a rigid plate material for body 78 further stiffens the A-arms while minimizing the volume/weight of material required.

The body 78 and the first, second, and third tubes 88, 90, 92, when collectively held in a fixture or jig prior to welding or connecting the tubes, promotes grinding or finishing to prepare the body or to complete the welds. The use of a fixture as noted above also establishes and maintains the coaxial alignment of the first and second tubes 88, 90, and maintains the parallel alignment of the second longitudinal axis 98 of the third tube 92 with respect to the first longitudinal axis 96 of the first and second tubes 88, 90, both before and during the welding process. Weld joints such as fillet welds can be used to connect the tubes to the body 78, however the present disclosure are not limited to a specific type of weld joint, or to the use of any specific weld process. Other processes such as brazing are also within the scope of the present disclosure.

Plate thickness “H” and a rounded or curving geometry of side walls 108, 110 (as best seen in FIGS. 4 and 6) where these walls connect to the tubes are predetermined so an impact load received from a front collision with an object at one of the first or second steerable wheels 16 or 18 can be absorbed. The impact load is received through third tube 92 and is substantially transferred to first tube 88 by side wall 108. Referring again to FIG. 4, an included angle β ranging between approximately 40 to 60 degrees, and in some embodiments being approximately 45 degrees, defined between a substantially straight portion of side wall 108 and second longitudinal axis 98, is also predetermined to maximize impact load transfer. The plate thickness “H”, the included angle described above, and the curving geometry of side walls 108, 110 proximate to the tube connections combine to increase the load carrying capability before yield of either first or second A-arm 50, 52. The use of tubing for first, second and third tubes 88, 90 and 92 which is welded or otherwise fixedly connected to first and second A-arms 50, 52 also increases the impact load which can be absorbed compared to known A-arm assemblies which have end plates rolled over or stamped to form connection tubes. Common A-arm designs are often not designed to absorb this type of impact load without yielding the material of the A-arm.

The description of the disclosure is merely exemplary in nature and, thus, variations that do not depart from the gist of that which is described are intended to be within the scope of the disclosure. For example, A-arms of the present disclosure are described herein with respect to use in a golf car suspension, however, the present disclosure is not limited to A-arms for suspension systems of golf cars and can be used in other vehicles such as off-road vehicles, all terrain vehicles, and the like. These other vehicles can include food/beverage carts, golf course maintenance vehicles, hunting/sport activity vehicles, and the like. Such variations are not to be regarded as a departure from the spirit and scope of the present disclosure.

What is claimed is:

1. A suspension system A-arm for a utility vehicle, comprising:
a generally Y-shaped, flat plate body having a first end and a second end;
a first and a second extension portion defining the first end;
a first tube member connected to the first extension portion;
a second tube member connected to the second extension portion, the second tube member configured in co-axial alignment with the first tube member; and
a third tube member connected to the second end of the body;
wherein a longitudinal axis extending through the first and second tube members is substantially parallel to a third tube member longitudinal axis.

2. The A-arm according to claim 1, wherein each of the first and second tube members comprise an equal first length.

3. The A-arm according to claim 2, wherein the third tube member comprises a second length greater than the first length of the first and second tube members.

4. The A-arm according to claim 1, further comprising:
a first side wall of the body having a substantially straight central portion transitioning into a curving portion proximate each of the first and third tube members; and
a predetermined angle ranging between approximately 40 to approximately 60 degrees defined between the straight central portion and a longitudinal axis of the third tube member.

5. The A-arm according to claim 4, further comprising a second side wall of the body having a substantially straight middle portion transitioning into a curving portion proximate each of the second and third tube members.

6. The A-arm according to claim 1, wherein the body comprises a substantially flat plate having a uniform thickness.

7. The A-arm according to claim 1, further comprising a weld joint connecting individual ones of the first, second, and third tube members to the body.

8. The A-arm according to claim 1, wherein each of the body and the first, second, and third tube members comprise a cold rolled 1018 steel.

9. A suspension system A-arm for a golf car, comprising:
a generally Y-shaped, flat plate body having a first end and a second end;
a first tube member connected to the first end;
a second tube member connected to the first end and spatially separated from the first tube member, the second tube member positioned in co-axial alignment with the first tube member;
a third tube member connected to the second end of the body; and
a plurality of body edges oriented substantially perpendicular to the flat plate body, the body edges including:
a first edge extending between the first tube member and the second tube member, the first edge defining a clearance cavity between the first and second tube members;
a second edge extending between the first tube member and the third tube member, the second edge being substantially perpendicular with respect to the plate body; and
a third edge extending between the second tube member and the third tube member, the second edge being substantially perpendicular with respect to the plate body.

10. The A-arm of claim 9, wherein the first end further comprises:
a first extension portion; and
a second extension portion;
wherein the first tube member is connected to the first extension portion and the second tube member is connected to the second extension portion.

11. The A-arm of claim 9, wherein a longitudinal axis extending through the first and second tube members is substantially parallel to a third tube member longitudinal axis.

12. The A-arm of claim 9, further comprising at least one weld joint connecting individual ones of the first, second, and third tube members to the body.

13. The A-arm of claim 9, further comprising a fixture pin locating aperture created in the body.

14. A golf car, comprising:
an independent front suspension system having at least one A-arm, the A-arm including:
a generally Y-shaped, flat plate body having a first end and a second end;
a first tube member connected to the first end;
a second tube member fixedly coupled to the first end and spatially separated from the first tube member, the second tube member positioned in co-axial alignment with the first tube member;
a third tube member fixedly coupled to the second end of the body; and
a longitudinal axis extending through the first and second tube members being substantially parallel to a third tube member longitudinal axis;
wherein each of the first and second tube members are connected for co-rotation about the longitudinal axis to a frame structure of the utility vehicle, and the third tube member is connected to a wheel structure of the utility vehicle.

15. The golf car of claim 14, wherein the at least one A-arm comprises an identical pair of A-arms reversibly oriented with respect to each other.

16. The golf car of claim 15, further comprising:
a first steerable wheel connected to the frame structure using a first one of the pair of A-arms; and
a second steerable wheel connected to the frame structure using a second one of the pair of A-arms.

17. The golf car of claim 14, wherein the first end further comprises:
a first extension portion; and
a second extension portion;
wherein the first tube member is welded to the first extension portion and the second tube member is welded to the second extension portion.

18. The golf car of claim 14, wherein each of the first and second tube members comprise an equal first length.

19. The golf car of claim 18, wherein the third tube member comprises a second length greater than the first length of the first and second tube members.

20. The golf car of claim 14, further comprising a weld joint operable to fixedly couple each of the tube members to the body.

21. A method for creating an A-arm for a utility vehicle, the A-arm having a body including a main plate section and first and second ends, the method comprising:
cutting the A-arm body from a substantially flat plate;
creating each of a first and a second extension at the first end of the main plate section; and
welding each of three tube members to the body, including a first tube member welded to the first extension, a second tube member welded to the second extension and a third tube member welded to the second end of the body.

22. The method of claim 21, further comprising coaxially aligning the first and second tube members on a common longitudinal axis prior to the welding step.

23. The method of claim 22, further comprising aligning a longitudinal bore axis of the third tube member substantially in parallel with the longitudinal axis of the first and second tube members prior to the welding step.

24. The method of claim 23, further comprising mounting the tube members and the body in a fixture to retain alignment of the tube members relative to each other prior to the welding step.
